(19) United States
(12) Patent Application Publication
(10) Pub. No.: US 2010/0238955 A1
(43) Pub. Date: Sep. 23, 2010

(54) METHOD AND DEVICE FOR COMMUNICATING USING HUMAN BODY

(76) Inventors: Jin-Bong Sung, Daejeon-city (KR); Sung-Weon Kang, Daejeon-city (KR); Jung-Hwan Hwang, Daejeon-city (KR); Chang-Hee Hyoung, Daejeon-city (KR); Jin-Kyung Kim, Daejeon-city (KR); Duck-Gun Park, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/303,975

(22) PCT Filed: May 29, 2007
(86) PCT No.: PCT/KR07/02596

§ 371 Date: Dec. 9, 2008

(30) Foreign Application Priority Data
Jun. 16, 2006 (KR) 10-2006-0054369

(51) Int. Cl. H04J 3/00

(52) U.S. Cl. 370/498

(57) ABSTRACT

A communication device and method is provided. The communication method using a human body includes modulating data, generating a first timing signal by using the modulated data, generating a wideband pulse with a short time interval on the basis of the first timing signal, and transmitting the wideband pulse through an electrode unit that contacts a human body.

### TECHNICAL FIELD

The present invention relates to a device for communication, and more particularly, to a method and device for communication using a human body as a transmission medium.

### BACKGROUND ART

Human body communication utilizes a human body as a transmission medium to transmit signals between electronic devices that are connected to the human body based on a principle in which electricity passes through the human body.

Various information communication devices such as personal digital assistants (PDAs), portable personal computers, digital cameras, MP3 players, mobile phones, etc are widely used. Users use a diverse range of multimedia services such as sending and receiving e-mails, downloading content data, etc. through these devices.

However, to transmit e-mails and content data stored in one communication device to another communication device, an adapter or connector, and a communication line such as a cable are required. Thus, sending and receiving data between the communication devices can be troublesome.

Moreover, when performing data communication by connecting devices adjacent to a human body to a cable, the weight of the devices imposes on the human body and at the same time the human body is limited in movement because of the cables connected between the devices.

The communication devices provide functions such as converting digital information into a voice signal, an internet service, and calling. Besides these functions, the communication devices provide common functions such as displaying, storing data in a memory, and processing digital signals. Therefore, human body communication has been under development to effectively use these functions of communication devices and thereby achieve effective use of communication resources and easy data communication between communication devices.

FIG. 1 is a view of a conventional communication device using an RF carrier frequency.

Referring to FIG. 1, the communication device utilizes the RF carrier frequency. However, because of a carrier frequency generating circuit 100, the structure of the communication device is complex, and noise and distortion in the communication device increases. Therefore, a relatively large number of control units are required to control gains and phase errors generated from the noise and the distortion. In the case of a communication device using the carrier frequency, the time and effort required to design a transmitting and receiving unit increases, and at the same time the structure becomes more complex.

### DISCLOSURE OF INVENTION

### Technical Problem

The present invention provides a communication device and method using a human body to communicate over a communication channel without using an RF carrier frequency.

### Technical Solution

According to an aspect of the present invention, there is provided a communication device using a human body, including: a modulating and multiplexing unit modulating data; a timing generator generating a timing signal using the modulated data; a pulse generator generating a wideband pulse having a short time interval on the basis of the timing signal; and an electrode unit contacting a human body for transmitting the wideband pulse through the human body.

According to another aspect of the present invention, there is provided a communication device using a human body, including: a front-end unit amplifying and filtering a wideband pulse signal received through an electrode unit contacting a human body; a timing generator generating a timing signal; and a correlator correlating the timing signal with the amplified and filtered signal.

According to a another aspect of the present invention, there is provided a communication method using a human body, including: modulating data; generating a timing signal by using the modulated data; generating a wideband pulse having a short time interval on the basis of the timing signal; and transmitting the wideband pulse through an electrode unit contacting a human body.

### Advantageous Effects

According to the present invention, since data is transmitted through a human body by using a wideband pulse with a short time interval and not by using an RF carrier frequency, a communication device having low power consumption can be achieved. Moreover, since a human body is used as a transmission medium, data leakage by hacking can be prevented. Since data is transmitted and spread in a broad bandwidth spectrum, communication is possible without interference with other narrowband signals.

### DESCRIPTION OF DRAWINGS

FIG. 1 is a view of a conventional communication device using an RF carrier frequency;

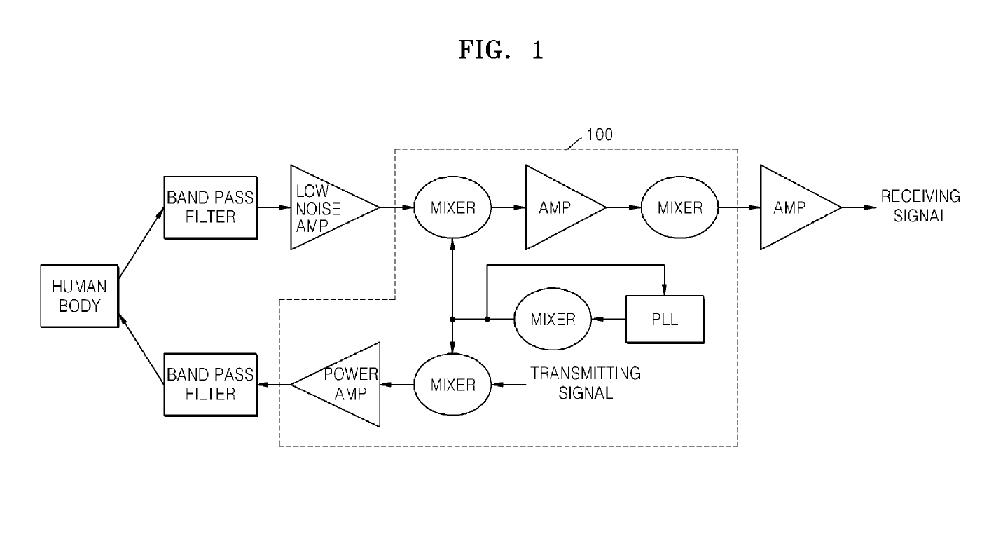

FIG. 2 is a view of a communication device using a human body;

FIG. 3 is a view of a communication system using communication devices according to an embodiment of the present invention;

FIG. 4 is a view of configuration of a communication device using a human body according to an embodiment of the present invention; and

FIGS. 5A and 5B are flowcharts of a communication method using a human body according to an embodiment of the present invention.

### BEST MODE

According to an aspect of the present invention, there is provided a communication device using a human body, including: a modulating and multiplexing unit modulating data; a timing generator generating a timing signal using the modulated data; a pulse generator generating a wideband pulse having a short time interval on the basis of the timing signal; and an electrode unit contacting a human body for transmitting the wideband pulse through the human body.

According to another aspect of the present invention, there is provided a communication device using a human body, including: a front-end unit amplifying and filtering a wideband pulse signal received through an electrode unit contacting a human body; a timing generator generating a timing signal; and a correlator correlating the timing signal with the amplified and filtered signal.

According to a another aspect of the present invention, there is provided a communication method using a human body, including: modulating data; generating a timing signal by using the modulated data; generating a wideband pulse having a short time interval on the basis of the timing signal; and transmitting the wideband pulse through an electrode unit contacting a human body.

### Mode for Invention

The present invention will now be described more fully with reference to the accompanying drawings, in which exemplary embodiments of the invention are shown.

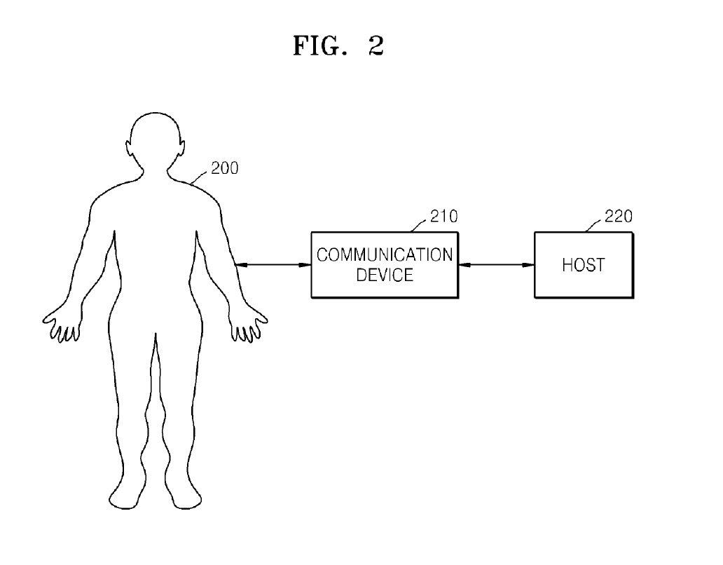

FIG. 2 is a view of a communication device using a human body.

Referring to FIG. 2, both ends of a communication device 210 are respectively connected to a human body 200 and a host 220. The host 220 connected to the communication device 210 can be various kinds of devices that include a self-computing function and a data processing function.

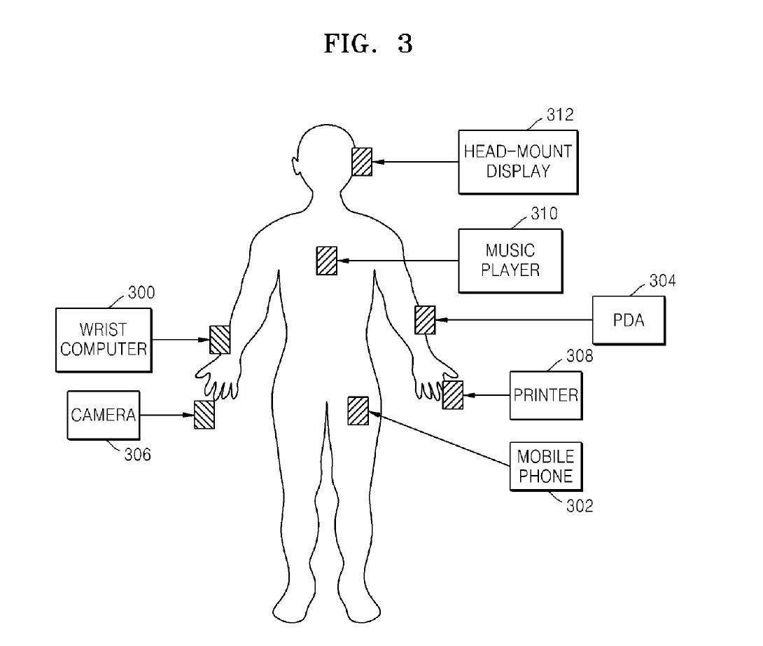

FIG. 3 is a view of a communication system using communication devices according to an embodiment of the present invention.

Referring to FIGS. 2 and 3, a plurality of communication devices perform communication by using the human body 200 as a transmission medium. The communication device 210 of FIG. 2 directly contacts the skin of the human body 200 and is connected to the host 220 in order to be able to transmit and receive signals.

The host 220 includes devices such as a wrist computer 300, a mobile phone 302, and a PDA 304, and various devices such as a camera 306, a printer 308, a music player 310, and a head-mount display 312.

The present invention utilizes the human body as a transmission medium that connects separated devices and components of a wearable computer.

Referring to FIG. 3, each of the hosts or the components of the wearable computer contacts the human body by using the communication device 210 of FIG. 2 as a medium. For example, the wrist computer 300 connected to the human body through the communication device 210 can transmit and receive data to/from other hosts (e.g., the printer 308, the camera 306, and an external computer) that are connected to the human body by using the human body as a transmission medium.

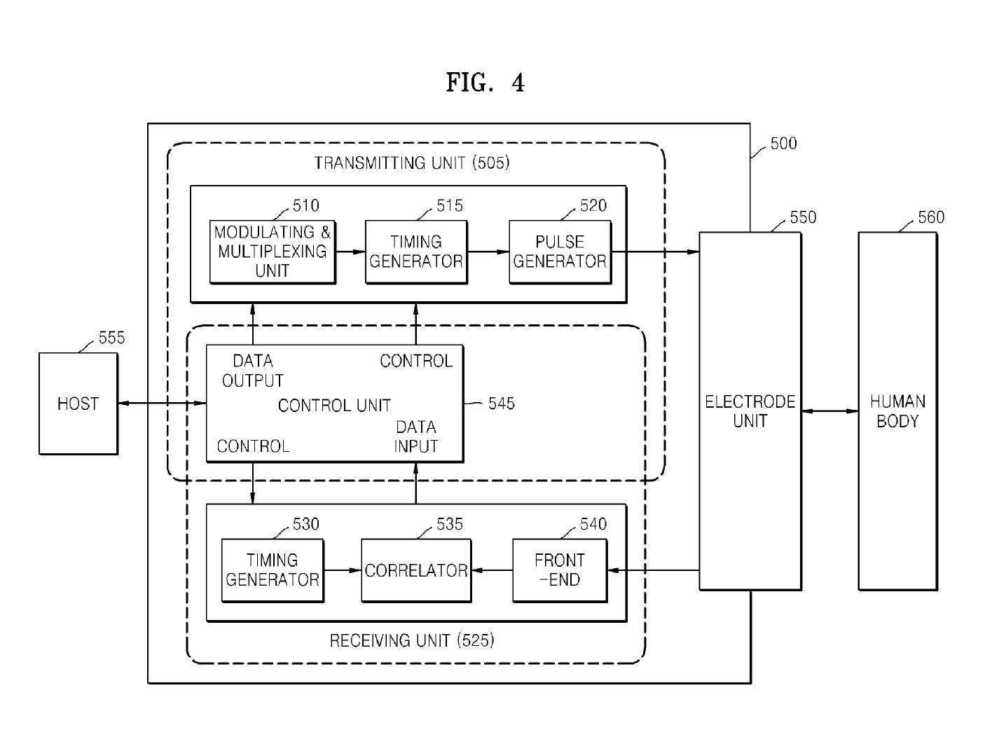

FIG. 4 is a view of configuration of a communication device using a human body according to an embodiment of the present invention.

Referring to FIG. 4, a communication device includes a transmitting unit 505, a receiving unit 525, an electrode unit 550, and a control unit 545. The transmitting unit 505 and the receiving unit 525 can be embodied separately. When the communication device 500 includes the transmitting unit 505 and the receiving unit 525, the control unit 545 controls both the transmitting unit 505 and the receiving unit 525, and also serves as an interface to input/output data to/from the transmitting unit 505 or the receiving unit 525. When the communication device 500 serves as the transmitting unit 505, the control unit 545 delivers a signal received from an external host 555 to the transmitting unit 505, and also controls the transmitting unit 505 to transmit the signal processed in the transmitting unit 505 to a human body 560 through the electrode unit 550. On the contrary, when the communication device 500 servers as receiving unit 525, the control unit 545 controls the receiving unit 525 to receive signals from the human body 560 through the electrode unit 550, and transmits the signals processed in the receiving unit 525 to the external host 555.

The receiving unit 505 generates a time-modulated timing signal based on information data and user identification data. The timing signal is a signal that represents time information for transmitting a wideband pulse. The receiving unit 525 demodulates signals received through the human body 560 into wideband pulses in order to restore data after acquiring synchronization using a correlator. The electrode unit 550 is in direct contact with the human body so it can transmit a signal in a current through the human body, and can receive the signal delivered from the human body.

More specifically, the transmitting unit 505 includes a modulating and multiplexing unit 510, a timing generator 515, and a pulse generator 520. The modulating and multiplexing unit 510 performs modulation in order to sort data and multiplexing in order to classify users. For the modulation, the modulating unit utilizes pulse position modulation (PPM), pulse amplitude modulation (PAM), binary phase shift keying (BPSK), quadrature phase shift keying (QPSK), and orthogonal frequency division multiplexing (OFDM). The timing generator 515 utilizes the modulated and multiplexed data to generate a timing signal. The pulse generator 510 generates a pulse according to the timing signal.

The receiving unit 525 includes a timing generator 530, a correlator 535, and a front-end unit 540. After receiving a signal transmitted through the human body 560 by using the electrode unit 550, the front-end unit 540 amplifies and filters the signal. The timing generator 530 generates a timing signal that is transmitted to the correlator 535. The correlator performs correlation in synchronization with the timing signal generated in the timing generator 500.

The control unit 545 checks and corrects errors of the signal inputted from the receiving unit 525, and recovers the signal received through the electrode unit 550. Moreover, the control unit 545 operates by defining communication order and rules between a plurality of communication devices that constitute a human communication network in order to prevent data collision. Therefore, data transmission efficiency is improved, and unnecessary use of communication resources can be prevented.

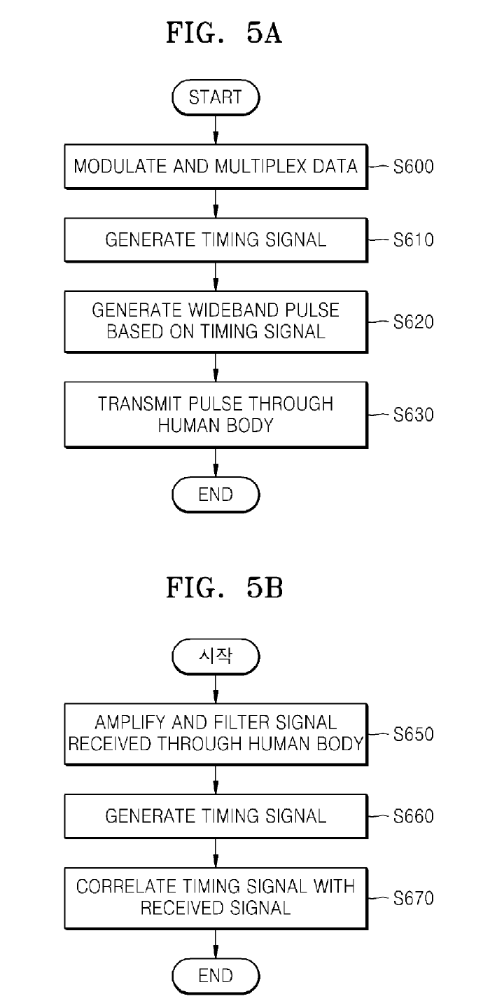

FIGS. 5A and 5B are flowcharts of a communication method using a human body according to an embodiment of the present invention.

Referring to FIG. 5A, in a method of transmitting data, a communication device modulates data received from the host through the control unit, and performs multiplexing so as to identify a user in operation S600. In operation S610, the communication device generates a timing signal using the modulated and multiplexed data. In operation S620, the communication device generates a timing pulse according to a timing signal. Additionally, the communication device transmits the generated pulse to another communication device through the human body in operation S630.

Referring to FIG. 5B, in a method of receiving data, the communication device receives a signal transmitted through the human body and amplifies and filters the signal in operation S650. The communication device generates a timing signal in operation S660, and correlates the timing signal with the filtered signal in operation S670 to recover and deliver the signal to the host through the control unit. Moreover, the signal restored in the receiving unit can be stored in a memory unit (not shown) of the communication device.

According to the present invention, since data is transmitted through a human body by using a wideband pulse with a short time interval and not by using an RF carrier frequency, a communication device having low power consumption can be achieved. Moreover, since a human body is used as a transmission medium, data leakage by hacking can be prevented. Since data is transmitted and spread in a broad bandwidth spectrum, communication is possible without interference with other narrowband signals.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention provides a communication device and method using a human body to communicate over a communication channel without using an RF carrier frequency.

1. A communication device using a human body, comprising:
a modulating and multiplexing unit modulating data;
a timing generator generating a timing signal using the modulated data;
a pulse generator generating a wideband pulse having a short time interval on the basis of the first timing signal; and
an electrode unit contacting a human body in order to transmit the wideband pulse through the human body.

2. The communication device of claim 1, wherein the modulating and multiplexing unit modulates the data using one of PPM (pulse position modulation), PAM (pulse amplitude modulation), BPSK (binary phase shift keying), QPSK (quadrature phase shift keying), and OFDM (orthogonal frequency division multiplexing).

3. The communication device of claim 1, wherein the modulating and multiplexing unit multiplexes the modulated data in order to identify users.

4. A communication device using a human body, comprising:
a front-end unit amplifying and filtering a wideband pulse signal received through an electrode unit contacting a human body;
a timing generator generating a timing signal; and
a correlator correlating the timing signal with the amplified and filtered signal.

5. A communication method using a human body, comprising:
modulating data;
generating a timing signal by using the modulated data;
generating a wideband pulse having a short time interval on the basis of the timing signal; and
transmitting the wideband pulse through an electrode unit contacting a human body.

6. The communication method of claim 5, further comprising:
amplifying and filtering the signal received from the human body through the electrode unit;
generating an additional timing signal; and
correlating the additional timing signal with the amplified and filtered signal.
